(19) United States
(12) Patent Application Publication
(10) Pub. No.: US 2026/0057441 A1
(43) Pub. Date: Feb. 26, 2026

(54) METHOD AND SYSTEM FOR IMPLEMENTING A RULES ENGINE

(71) Applicant: Royal Bank of Canada, Toronto (CA)

(72) Inventors: Timothy Zheng, Markham (CA); Hisham Ladha, Montreal (CA); Masha Solaja, Toronto (CA); Andrew Chen, Toronto (CA)

(21) Appl. No.: 19/306,639

(22) Filed: Aug. 21, 2025

Related U.S. Application Data
(60) Provisional application No. 63/685,972, filed on Aug. 22, 2024.

(51) Int. Cl. G06Q 40/04

(52) U.S. Cl. CPC G06Q 40/043

(57) ABSTRACT

Methods, systems, and techniques for applying a rules engine. Rules corresponding to trigger conditions to be evaluated in respect of a client, and client data pertaining to the client, are obtained. The rules are applied by the rules engine so as to evaluate trigger conditions in respect of at least one product and in respect of at least one document requirement that requires the client to provide a particular document or class of document prior to purchasing the at least one product. The result of applying the rules is a matrix that summarizes, for each of the at least one product, which of the at least one document is required for the client to purchase the product.

### CROSS-REFERENCE TO RELATED APPLICATIONS

This application claims priority to and benefit of U.S. patent application No. 63/685,972, filed on Aug. 22, 2024, and entitled “METHOD AND SYSTEM FOR IMPLEMENTING A RULES ENGINE”, the entirety of which is hereby incorporated by reference herein.

### TECHNICAL FIELD

The present disclosure is directed at methods, systems, and techniques for implementing a rules engine.

### BACKGROUND

The amount of data being generated in daily life continues to exponentially increase. Not only is the overall volume of data increasing, but the types of that data, the sources of that data, and the applications for that data continue to dramatically increase as well. Being able to leverage diverse and ever-growing types of data for practical applications, such as research and sales opportunities, accordingly remains desirable.

### SUMMARY

According to a first aspect, there is provided a rules engine application method, the method comprising: obtaining rules corresponding to trigger conditions to be evaluated in respect of a client, and client data pertaining to the client; applying the rules using the client data to evaluate the trigger conditions in respect of at least one product and in respect of at least one document to be provided by the client prior to purchasing the at least one product; and as a result of applying the rules, generating a matrix summarizing, for each of the at least one product, whether the client providing the at least one document permits the client to purchase the product.

Each cell of the matrix may be populated with a Boolean value.

Each of the trigger conditions may be evaluated using a handler function that outputs a Boolean value representing whether the trigger condition is satisfied, and any one of the handler functions returning a false Boolean value for a particular cell of the matrix may result in the particular cell being false.

The rules may be obtained in multiple first formats and, prior to applying the rules, the method may further comprise converting the rules into a shared second format.

Converting the rules may comprise tokenizing the rules using regular expressions.

The rules in at least one of the first formats may be stored in a spreadsheet, and the shared second format may be JavaScript Object Notation.

According to another aspect, there is provided a rules engine application method, the method comprising: obtaining trigger conditions corresponding to rules defining document requirements for at least one product to be evaluated in respect of a client, and client data pertaining to the client; applying the rules by evaluating the trigger conditions using the client data in respect of the at least one product; and as a result of applying the rules, generating a document requirement matrix, the document requirement matrix comprising, for each of the at least one product, an indication for each of a plurality of document classes corresponding to whether the client is required to provide a document of the respective document class to purchase a respective product.

Each cell of the document requirement matrix may be populated with a Boolean value corresponding to the indication of whether the client is required to provide the document of the respective document class to purchase the respective product.

Each of the trigger conditions may correspond to a rule or attribute thereof; Each of the trigger conditions may be evaluated using a handler function that outputs the Boolean value representing whether a respective trigger condition is satisfied.

Any one handler function returning a false Boolean value for a particular cell of the matrix may result in the particular cell being false and all handler functions returning a true Boolean value for the particular cell results in the particular cell being true; and the particular cell being false may represent that one of the trigger conditions for requiring the client to provide the document of the respective document class is unsatisfied, and the particular cell being true may represent that all of the trigger conditions for requiring the client to provide the document of the respective document class are satisfied.

Each of the trigger conditions may correspond to a respective attribute of the rules and a respective attribute of the at least one product or the client data; and the handler function may return the true Boolean value if the respective attribute of the rules matches the respective attribute of the at least one product or the client data.

A trigger matcher function may map the respective attribute of the rules to the respective attribute of the at least one product or the client data for the handler function.

The handler function may be dynamically dispatched for each cell based on the respective document class and the respective product.

The rules may be obtained in one or more first formats and, prior to the applying of the rules, the method may further comprise converting the rules into a shared second format.

The converting of the rules may comprise: processing the rules in the one or more first formats to extract relevant rules information; splitting the relevant rules information into individual trigger conditions; and tokenizing the individual trigger conditions to map attributes in the individual trigger conditions into standardized terms.

The rules in the one or more first formats may be stored in a spreadsheet; the shared second format may be JavaScript Object Notation (JSON); and the individual trigger conditions may each correspond to a respective JSON object.

The processing of the rules may comprise: extracting rows and columns of the spreadsheet into a two-dimensional data structure; removing irrelevant rows and columns to extract the relevant rules information; and indexing the relevant rules information based on the plurality of document classes.

The splitting of the rules may comprise extracting the individual trigger conditions using regex and splitting conditions.

The tokenizing of the individual trigger conditions may comprise: converting the individual trigger conditions into dictionary objects; consolidating the attributes in the individual trigger conditions into the standardized terms; and converting each of the individual trigger conditions into the respective JSON object.

The rules engine application method may further comprise: storing the rules of the shared second format in a repository.

The applying of the rules may comprise loading the handler function with the respective JSON object retrieved from the repository.

The rules engine application method may further comprise: prior to the applying of the rules, parsing the repository for the rules of the shared second format, the converting of the rules may be dependent on the parsing determining that the rules of the shared second format are not available.

The rules engine application method may further comprise: retrieving product information for the at least one product, the trigger conditions may comprise a trigger condition evaluated using the product information.

The product information may be obtained in one or more third formats and, prior to the applying of the rules, the method may further comprise converting the product information into a fourth format.

The fourth format may be a class object; and the converting of the product information may comprise: processing the product information in the one or more third formats to extract relevant product information; tokenizing the relevant product information to map attributes in the relevant product information into standardized terms; and grouping classes of the at least one products using a product matching function.

The class object may define a product category, a product type, a product sub-type, a product booking entity, or combinations thereof; The class object may comprise a string method for printing the class object, a hash method for returning a hash value of the class object, a conversion method for converting the class object into a corresponding JSON object, or combinations thereof; and the class object may comprise the product matching function, the product matching function configured to group the classes of the at least one product based on the product category, the product type, the product sub-type, the product booking entity, or combinations thereof.

The applying of the rules may comprise: ingesting a first file comprising the trigger conditions for the at least one product, and a second file identifying acceptable documents for the plurality of document classes.

The rules engine application method may further comprise: evaluating the document requirement matrix against document information corresponding to documents provided by the client to determine additional documents to be provided by the client to purchase the at least one product, wherein the client data comprises the document information.

The rules engine may be implemented on a back-end of a server system and communicatively coupled to a user interface implemented on a front-end of the server system using an API endpoint; the back-end of the server system may host at least one first internal database storing the client data, the client data retrievable on a basis of a client identifier received from the user interface; and the back-end of the server systems may host at least one second internal database storing the trigger conditions.

According to another aspect, there is provided a system comprising: at least one network interface; at least one processing unit communicatively coupled to the at least one network interface, in which the at least one processing unit is configured to perform any one or more of the above-described methods.

According to another aspect, there is provided at least one non-transitory computer readable medium having stored thereon computer program code that is executable by at least one processor and that, when executed by the at least one processor, causes the at least one processor to perform any one or more of the above described methods.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 is a network diagram illustrating one architecture used to implement a rules engine, according to an example embodiment.

FIG. 2 is a block diagram of a server comprising part of the architecture of FIG. 1.

FIG. 3 is a block diagram of a rules engine, according to an example embodiment.

FIG. 4 is an example matrix output by the rules engine, according to an example embodiment.

FIGS. 5A and 5B show attribute handling for rule application within the rules engine, according to an example embodiment.

FIG. 6 shows the interface of a software class used for saleable products, according to an example embodiment.

FIG. 7 is a block diagram of the rules engine, according to an example embodiment.

FIG. 8 is an architecture diagram of a system comprising the rules engine, according to an example embodiment.

FIGS. 9A and 9B show a flowchart depicting a process for applying the rules engine to generate the matrix, according to an example embodiment.

### DETAILED DESCRIPTION

From a technical perspective, the varied types, sources, and applications of data—more so than simply the volume of data per se, which computers are generally well equipped to handle—pose a technical problem in that computers must be specifically configured to be able to ingest, process, and apply that data efficiently and easily.

The various embodiments described herein are directed at solving the technical problem of ingesting, processing, and applying data of different types and sources, and for different applications. This is done by particularly configuring a computer to read a set of rules in one or more first formats; if necessary, to convert those rules into a common second format; and then to apply those rules to process ingested data. As described further below, in some embodiments the data represents various clients; products; trigger conditions that, when satisfied according to the rules, permit clients to purchase those products subject to the client satisfying certain condition(s) (e.g., providing a certain document or class of document) to the seller. Also as further described below, configuring a computer to implement this functionality may comprise using regular expressions to parse rules in one of the first formats so as to identify how to convert them into the second format, which may be JavaScript Object Notation (“JSON”) files; and then applying various handler functions to apply the rules to the data in the form of those clients, products, and trigger conditions so as to generate matrices representing whether the clients qualify to purchase those products and, if so, what documents those clients need to provide. However, the data, rules, and output may take different forms in other embodiments.

Applications of the present disclosure include onboarding of assets, clients, and documents. As an example, a financial institution may be interested in cross selling products to their existing clients. Currently, to cross-sell, a salesperson of the institution generally directly engages a client to initiate a conversation regarding their business needs in additional asset classes. If a salesperson comes to an agreement with a client regarding their desire to transact a specific product outside of their current coverage area, they will introduce the client to another salesperson responsible for trading the product. The other salesperson then initiates the onboarding process for the client onto the new product, which triggers a series of requirements to be satisfied. The onboarding process often results in the collection of documents from the client and necessitates additional operational overhead for both the client and the salespersons.

A number of challenges exist in this scenario. Currently, the cross-selling process is largely manual, which requires significant operational effort on the people involved in the process. Salespersons may not have visibility into what documents the institution currently holds for the client, and hence which asset class creates minimal additional work to onboard a client onto. Relationship managers, responsible for ensuring client satisfaction and continued revenue growth, also generally do not have a bird's eye view of the cross-asset sales opportunities for every client. Further, clients are not shown additional asset classes they could trade which would require fewer documents to be submitted prior to them being onboarded.

Accordingly, the present disclosure can provide systems and methods which facilitate the onboarding of assets. The disclosed systems and methods can analyze policies and rules governing assets (e.g., products) to determine the documents required for the asset. To determine document requirements, source data comprising requirement rules can also be parsed and processed to extract and standardize the document requirements. As a number of different documents may be acceptable for a particular requirement, the disclosed systems and methods can process the documents which have already been onboarded to determine if any of the onboarded documents satisfy the requirement. As such, the present disclosure can identify the additional documents required to onboard an asset as well as the number of additional documents required. By performing the analysis for multiple assets, the present disclosure can also determine, based on the number of additional documents required, which assets are easier to onboard. More particularly, the present disclosure can eliminate the need to manually parse through thousands of spreadsheet cells, trying to interpret the data and then subsequently having to look for the overlap in document requirements. Thus, the present disclosure can provide an improvement in document management and asset onboarding.

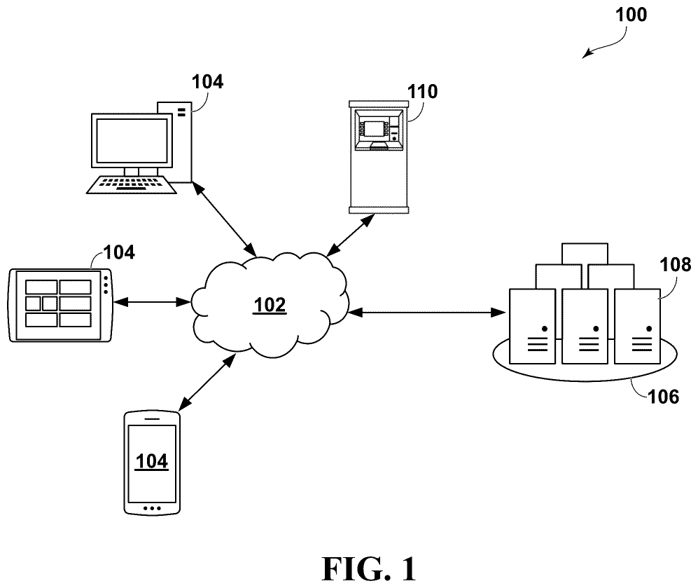

Referring now to FIG. 1, there is shown a computer network 100 that comprises an example embodiment of a method and system for implementing a rules engine. More particularly, the computer network 100 comprises a wide area network 102 such as the Internet to which various user devices 104, an ATM 110, and data center 106 are communicatively coupled. The data center 106 comprises a number of servers 108 networked together to collectively perform various computing functions. For example, in the context of a financial institution such as a bank, the data center 106 may host online banking services that permit clients to log in to those servers using client accounts that give them access to various computer-implemented banking services, such as online fund transfers. Furthermore, individuals may appear in person at the ATM 110 to withdraw money from bank accounts controlled by the data center 106.

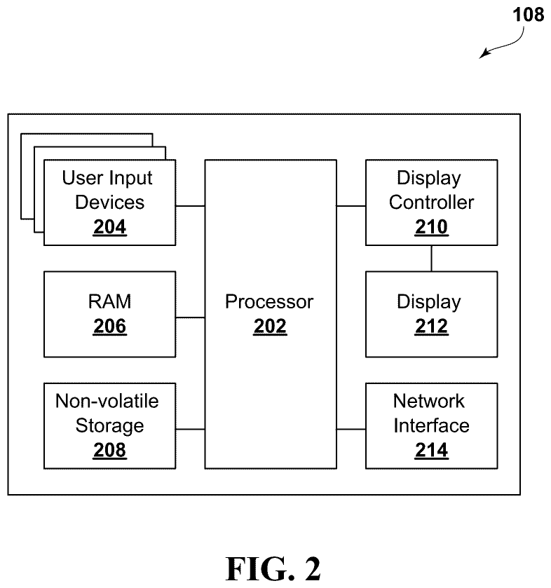

Referring now to FIG. 2, there is depicted an example embodiment of one of the servers 108 that comprises the data center 106. The server comprises a processor 202 that controls the server's 108 overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 104 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to act as a back-end for the rules engine, such as is described in more detail below. Additionally or alternatively, the servers 108 may collectively perform that method using distributed computing. While the system depicted in FIG. 2 is described specifically in respect of one of the servers 108, analogous versions of the system may also be used for the user devices 104, which depict a front-end of the rules engine.

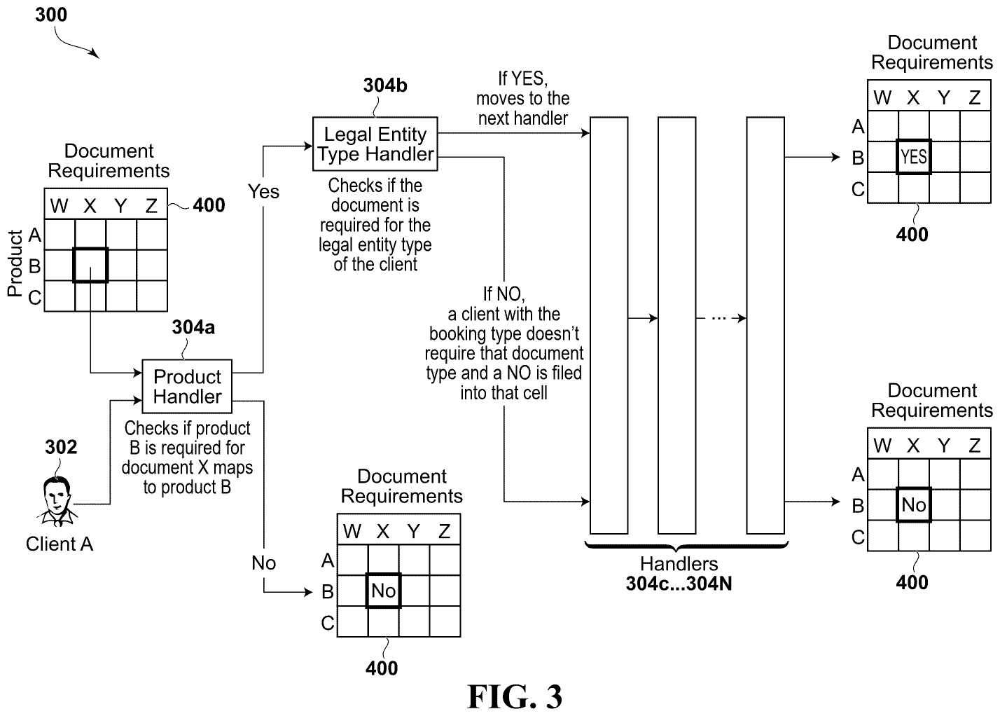

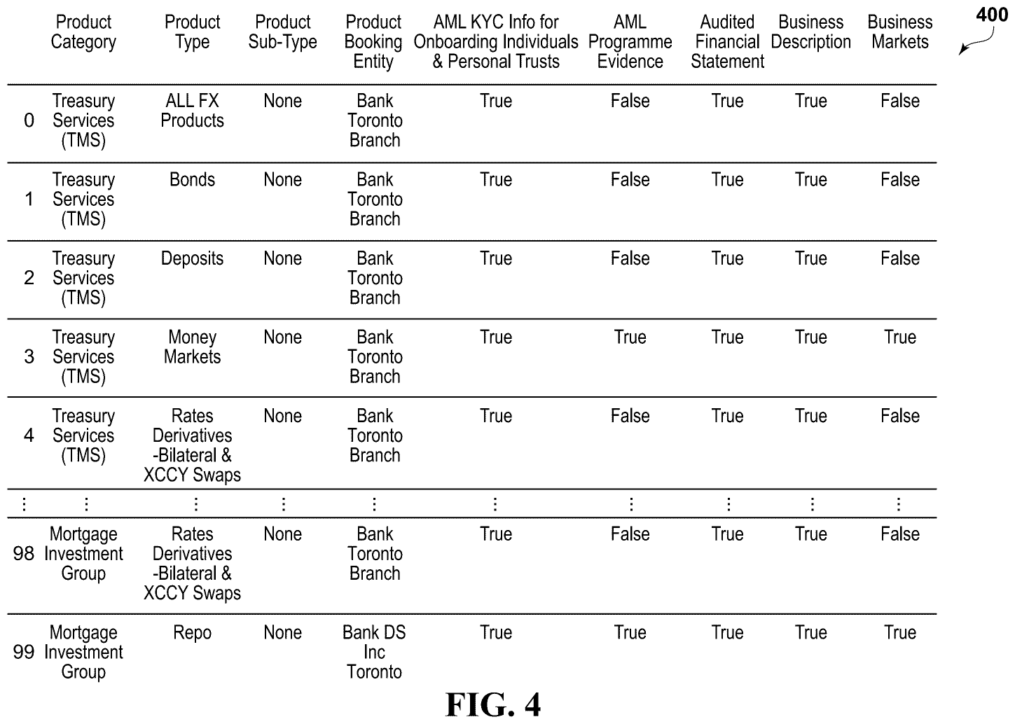

Referring now to FIG. 3, there is depicted a block diagram of a rules engine 300, according to an example embodiment. The rules engine 300 of FIG. 3, and as described further below in respect of FIGS. 4-8, is in the context of products, such as financial products, that are potentially available for purchase by clients of an institution such as a bank or other financial institution. While the rules engine 300 is described below with respect to products, it should be noted that the present disclosure is generally applicable for any items/conditions that require documents in order to be transacted or satisfied.

Broadly, the rules engine 300 may be implemented by an entity (e.g., the financial institution) having access to documents provided by a client 302 to the entity. A user may interact with the rules engine 300 to determine the additional documents that the entity currently does not have access to and/or number thereof required to be provided to the entity in order to transact one or more products or assets. To interact with the rules engine 300, a graphical user interface can be provided. The user may be the client 302 interested in purchasing additional products and accordingly may like to know the additional documents and number thereof required for those products. Alternatively, the user may be from the entity that is interested in onboarding or selling additional products to the client 302; in such a case, they may recommend or sell the products based on the case of onboarding, which is dependent on the number of additional documents required from the client.

In order to qualify to purchase products from the institution, the client 302 needs to satisfy various “trigger conditions” embodied by rules that the rules engine 300 applies, and also provide certain document(s) to the financial institution. In the context of documents, the trigger conditions determine whether a document (particularly of a specific class) is required for a client to onboard a particular product. For example, a trigger condition of a document may evaluate to “True” if an aspect of the client 302 meets a condition set by the document and/or product corresponding thereto, thus requiring the client 302 to provide that document. Conversely, a trigger condition of a document may evaluate to “False” if the client 302 is exempt from providing the document for the product or has already provided the document or an equivalent thereof. Note that other evaluators (e.g., yes/no) and conventions are possible in addition or as an alternative to “True”/“False” as well.

In the present embodiment, the rules engine 300 ingests and applies the rules to determine whether the trigger conditions are satisfied in respect of a particular client, particular product(s), and particular document(s) or class(es) of documents, and outputs a matrix summarizing that analysis for subsequent analysis. That matrix may then be analyzed, such as via the graphical user interface, to determine which products can be sold to clients for the least amount of effort (e.g., products where all trigger conditions are met but for provision of a small number of documents). This may be done as part of a client onboarding process at a financial institution.

The rules engine 300 begins by ingesting two files, retrieved from an internal database, provided by the user, or generated by the rules engine 300:
1. A “Document Requirements” file, which comprises a list of rules governing the trigger conditions for one or more particular documents and/or classes of documents. An excerpt from an example “Document Requirements” file is given below in Table 1, for an embodiment where the “Document requirements” file is a spreadsheet.

TABLE 1
Excerpt of “Document Requirements” File

| | Document | |
|---|---|---|
| Jurisdiction | Class Name | Trigger Conditions |
| Canada | Proof of | Jurisdiction = Canada |
| | Formation | Exemption Status = Exempt or Non-Exempt |
| | | Valid Exempt Reasons = <Reason A>, <Reason B> . . . |
| | | Legal Entity = <Entity Type A> or <Entity Type B> or . . . or |
| | | <Entity Type Z> |
| | | Exception = <Exception Reason XYZ> or <Exception Reason |
| | | ABC> |
| | | Product Type = <Product 1>, <Product 2>, <Product 3>, . . . , |
| | | <Product N> |
| Canada | Document | Jurisdiction = Canada |
| | XYZ | Exemption Status = Exempt or Non-Exempt |
| | | Valid Exempt Reasons = <Reason A>, <Reason B> . . . |
| | | Legal Entity = <Entity Type A> or <Entity Type B> or . . . or |
| | | <Entity Type Z> |
| | | Exception = <Exception Reason XYZ> or <Exception Reason |
| | | ABC> |
| | | Product Type = <Product 1>, <Product 2>, <Product 3>, . . . , |
| | | <Product N> |

As evident from the above excerpt, the Document Requirements file may also include jurisdiction of the product.
In the above example, the “Document Requirements” file is given as a list of document classes, in which each document has a set of corresponding trigger conditions. Each document class may be required to satisfy a document requirement for one or more products.
The trigger conditions in the above excerpt for the document classes are: the jurisdiction of the product and/or the client; the client's exemption status (either “exempt” or “non-exempt”; in the above table, exemption status is non-limiting since both exempt and non-exempt clients are permitted); the client being a legal entity of an enumerated type (e.g., individual, corporation, etc.); the client's qualification for any enumerated “exceptions”, which refer to any one or more reasons that that if, if satisfied, would not require the client to provide the corresponding document or document class to the financial institution; and the product in question listed as one of the enumerated product types. However, each document or document class may have its own distinct set of trigger conditions.
With continued reference to Table 1, a first trigger condition for a jurisdiction may evaluate to “True” if the client and/or product belongs to the listed jurisdiction (Canada), thus indicating the corresponding document class may be required. A second trigger condition for exemption status may evaluate to “True” if the client is marked or previously identified as “non-exempt”, thus indicating the corresponding document class may be required, or vice versa. A third trigger condition for legal entity may evaluate to “True” if the client belong to an entity of the enumerated types, thus indicating the corresponding document class may be required. For example, for an “Entity Type A” client, they may be required (if all the other required trigger conditions are also true) to provide the corresponding document class. However, for an “Entity Type 2” client, not listed under the enumerated types, the client would not be required to provide the corresponding document class as the trigger condition would evaluate to “False” and consequently not all trigger conditions would be satisfied. A fourth trigger condition for “client exception” may evaluate to “True” if the client's qualifications, status, attributes, etc. do not fall under one of the enumerated “exceptions”, thus indicating the corresponding document class may be required. A fifth trigger condition for products may evaluate to “True” for any products belonging to one of the enumerated products, thus indicating the corresponding document class may be required. That is, the trigger conditions, taken in combination, determine whether the document class is required for a particular product. If all trigger conditions for a particular document class are satisfied, the document is required; analogously, if any trigger conditions for a particular document class are unsatisfied, the document class is not required.
Note that the enumerated types may identify clients or products that are either required or not required to provide a document of the corresponding class. For example, in contrast to Table 1, the enumerated entity statuses may list entity statuses which do not need to provide a document of the corresponding class and accordingly, the trigger condition will only evaluate to “True” if the client's entity type does not appear in the list. Further, although the above example shows multiple enumerated types corresponding to a single trigger condition, each of the types may instead correspond to a trigger condition to simplify implementation. For example, a trigger condition can evaluate to “True” if the legal entity of the client is “Entity Type A” and “False” otherwise; another trigger condition can evaluate to “True” if the legal entity of the client is “Entity Type B” and “False” otherwise; etc.
As described in further detail below, these trigger conditions are provided in an example first format, and are subsequently converted into a second format (in the present disclosure, JSON), following which the rules engine 300 applies the rules. In at least some embodiments, in the trigger conditions column, the “Product Type” rule is the only rule that is product focused (i.e., the rules engine 300 evaluates it by considering the product at issue) whereas the remaining trigger conditions are client focused. The “exception reason” condition is analogous to a counter-check in that if satisfied the client does not need to provide the corresponding document, and this type of counter-check is facilitated using the handler functions described herein.
2. A “Document Class Mapping” file, which comprises a list of example documents that fall within the document class identified in the “Document Requirements” file. An excerpt from an example “Document Class Mapping” file is given below in Table 2, for an embodiment where the “Document Class Mapping” file is a spreadsheet.

TABLE 2
Excerpt of “Document Class Mapping” File

| Document Requirement | Specific Document Name |
|---|---|
| Proof of Formation | 10K |
| Proof of Formation | 5500 Form for Pension Plans |
| Proof of Formation | Annual Report |
| Proof of Formation | Articles/Certificate of Incorporation |
| Proof of Formation | Extract from the Company Register |
| Proof of Formation | LLC Agreement |
| Proof of Formation | Memorandum & Articles of Association |
| Proof of Formation | Offering Circular/Memorandum/Prospectus |
| Proof of Formation | Partnership Agreement |
| Proof of Formation | Proof of Charitable Status |
| Proof of Formation | State Business License |
| Proof of Formation | Trust Agreement |
| Proof of Formation | Trust Deed |
| Proof of Formation | Withholding Statement |

That is, in the “Document Class Mapping” file, for each and every document class (e.g., in the “Document Requirements” file), a list of documents or names thereof that falls under the document class is given. As one or more different documents can be used interchangeably to satisfy any given document class, this file lists all equivalent documents that can be used for each and every document class. Accordingly, any of the documents listed for a document class can be used to satisfy conditions that require said document class.
In the current embodiment, the “Document Requirements” file and “Document Class Mapping” file can be utilized for all products and all clients.

Upon execution, the rules engine 300 ingests the “Document Requirements” and “Document Class Mapping” files, and reads and parses the rules set forth in the “Trigger Conditions” column identified in the “Document Requirements” file. Next, the rules engine 300 receives and relays client login credentials and uses them to retrieve, from a back-end such as an internal database, additional information related to the client 302. This information comprises the documents that the client 302 has already sent to the institution, the products they already have purchased, and other client attributes such as the client's jurisdiction and legal entity type. In some embodiments, the user may provide a unique client identifier (e.g., a numeric identifier) for the client 302, which is used to retrieve the information associated with the client 302. The user may also provide the name of the client 302, with which the rules engine 300 parses a client database to retrieve the client identifier and/or information.

With client data and the trigger conditions in hand, the rules engine 300 applies the rules corresponding to the trigger conditions to determine if the trigger conditions have been satisfied, as described further below. The output of applying these rules is a tabular data object exemplified as a matrix 400, an example of which is provided in FIG. 4 discussed below, of at least one product vs. at least one document class requirement. The rules engine 300 fills the matrix 400 by iterating through each document class requirement and, in each iteration, looping through each of the products as well, by passing the client data through one or more handler functions (“handlers”) to evaluate trigger conditions and accordingly confirm whether that particular document is required for that product.

In FIG. 4, the matrix 400 has an arbitrary number of 99 rows, with each row corresponding to a different product; and columns 1-9, respectively labeled Product Category (col. 1), Product Type (col. 2), Product Sub-type (col. 3), Product Booking Entity (col. 4), AML KYC Information (col. 5), AML Program Evidence (col. 6), Audited Financial Statement (col. 7), Business Description (col. 8), and Business Markets (col. 9). Of these columns, columns 5-9 represent different types of documents that clients would need to provide (for example, corresponding to a document class), with values in the matrix 400 in columns 5-9 being “True” or “False”. Generally, each row corresponds to a particular product, and each column corresponds to a document class. As such, the number of rows is dependent on the number of products the rules engine 300 is analyzing, which can be the entire catalogue of products or a selection therefrom as defined by the user. Similarly, the number of columns is dependent on the number of document classes the institution accepts for onboarding products. That is, while not all document classes are required for some products, the columns nevertheless list all possible document classes. Columns 2-4 can provide general information for each respective product and may be populated automatically by the rules engine 300 and may be omitted in some embodiments.

A cell is marked “True” only if all the handlers applied in respect of that cell return “True” (i.e., all trigger conditions are satisfied), and is otherwise marked “False” (i.e., any one or more trigger conditions is unsatisfied). “True” means that the type of document corresponding to that column (e.g., a document belonging to the document class) is required from the client 302 to acquire the corresponding product. Specifically, a “True” evaluation for a cell indicates that the corresponding document class (indicated by the column) is required from the client for the corresponding product (indicated by the row), regardless of whether the client has provided documents of the corresponding class already. “False” means that the document class is not required from the client 302 for the corresponding product (e.g., if the product does not need this class of documents to be onboarded or if the client 302 is excepted from providing this class of documents for the product). In some embodiments, “False” can also mean that the client does not qualify to acquire that product regardless of whether they have the corresponding document, and consequently no further action needs to be taken in respect of that product. Accordingly, within a row, the cells marked as “True” indicate all document classes required for the corresponding product.

In order to generate this output, for each cell of the matrix 400, the rules engine 300 applies at least one of the handlers, with each of the handlers outputting a binary True/False output, and with any one of the handlers returning False resulting in that cell being marked False and the rules engine 300 terminating handler processing for the cell. At least one handler is respectively responsible for evaluating at least one trigger condition. For example, each handler can determine whether the client 302 would be required to provide a document of the corresponding class for the corresponding product or whether a client qualifies to purchase the corresponding product given the client's residency, or legal entity status. The result is that the matrix 400 may be used to determine which clients qualify to purchase which products for the least effort. That is, the number of “True” values for a given row indicates the total number of document classes required for the corresponding product of that row. This matrix 400 can be stored in association with the client in an internal database of the institution and does not need to be updated unless attributes (e.g., entity type) of the client or document requirements for a product changes, thereby potentially affecting trigger condition evaluation.

Accordingly, the “True” values for any given row of the matrix 400 may be summed, and when subtracted against the documents (of the corresponding classes) the client 302 has already provided, result in an indication of how much effort in terms of additional document requirements would be required from the client in order for them to qualify to purchase that product. Specifically, the rules engine 300 can retrieve the information for the client 302 as specified above. Given the documents from the client currently in possession by the institution, the rules engine 300 can generate a list of currently held/available document classes using the “Document Class Mapping” file. For each cell, by matching already provided document classes to the document classes marked as “True”, the rules engine 300 can determine the document classes still required for each product. For example, the rules engine 300 can generate a new (e.g., updated) matrix by updating the matrix 400 to change cells from “True” to “False” if the client 302 has already provided the document(s) under the document class(es) (and as such would no longer be required to provide documents of this document class). A subsequent tally of “True” values for each row would then indicate the number of documents that the client 302 would still need to provide in order to qualify/onboard the product of the row. This updated matrix can also be saved in association with the client in the internal database, and may be updated each time the client 302 provides new documents and/or when the trigger conditions change. The tally and other information comprised in the matrices may be conveyed by informing the user of the rules engine 300 in a number of ways. The rules engine 300 can use the updated matrix to identify, for each product, the documents that have and have not been provided as well as other useful information including the number of document classes that have yet to be provided (e.g., corresponding to the sum of “True” cells in the subsequent matrix). In some embodiments, the rules engine 300 can indicate that “x/y” documents have been provided, where x is documents that have been provided (e.g., corresponding to the sum of “True” cells in the original matrix 400 minus the sum of “True” cells in the updated matrix), and y is total documents required (e.g., corresponding to the sum of “True” cells in the original matrix 400), textually and/or graphically (e.g., in chart form). Accordingly, the rules engine 300 can use the matrices to determine, based on the product requirements, client attributes, and current documents, which products would require the least number of additional documents from the client to onboard. Other embodiments for tracking the documents already provided by the client 302 in comparison to the required documents are possible as well. For example, the rules engine 300 can mark up the matrix 400 to indicate whether a document of the corresponding class has been provided or generate a list of documents that still needs to be provided using the matrix 400 as described above.

Referring back to FIG. 3, depicting an example embodiment of the rules engine 300 described above, first through N^{th} handlers 304a . . . N (generally, “handlers 304”) are provided, where N may be any positive integer. The trigger conditions are provided to the handlers 304, which starts with a blank instance of the matrix 400, initialized using all document classes and products. Each handler 304 may be configured to evaluate one of the possible trigger conditions, and accordingly the number of handlers 304 may be equal to the number of trigger conditions. In the current embodiment, each handler 304 may be implemented as a function, method, or object. The first handler 304a evaluates a first trigger condition, which in this example determines whether Product B, corresponding to the 2^{nd} row in the matrix 400, requires the client to supply a particular document (e.g., a document of class X in this example, where each class includes one or more documents) in order to qualify to purchase the product. If the document is not required for the product (based on client attributes and product requirements in the “Document Requirements” file), that cell of the matrix 400 is labeled “False” (“NO” in FIG. 3), and no further computation in respect of that document/product combination is required. If the first handler 304a returns “True”, then the rules engine 300 applies the second handler 304b to the same cell in respect of a subsequent (second) trigger condition such as client attribute (in FIG. 3, it is whether any document is required given the legal entity status of the client). If the result of the second handler 304b is “False”, then that cell is again labeled “False” and no further computation for that cell is required. If the result of the second handler 304b is “True”, then the third handler 304c is applied for the next trigger condition, and so on, until all the handlers 304a . . . N have returned “True” (that is, all trigger conditions have been evaluated) in which case that cell is marked “True”, or until one of the handlers 304a . . . N returns “False”, in which case that cell may immediately be marked “False”.

While FIGS. 3 and 4 depicts the evaluation of “True” and “False” for required and non-required document classes, respectively, the use of “True” and “False” to respectively indicate non-required and required document classes is possible as well.

### Rules Ingestion

As described above, the rules engine 300 ingests rules corresponding to trigger conditions from spreadsheet form into a form usable for evaluation by the handlers 304. Following ingestion, the rules are semantically parsed and transformed into trigger conditions executable by the handlers 304. More particularly, the language used to express rules in a spreadsheet in one of the first formats is converted into a second format (e.g., JSON) using semantic parsing methods. Those converted rules are loaded into the rule engine's 300 memory and applied to client-related data as trigger conditions via the handlers 304. Operating in this manner in the context of selling products in connection with a capital markets account helps process rules stored in a variety of first formats by converting them into a shared common format, which may then be applied by the handlers 304 to generate matrices 400 that may be used to assess which products can be sold to clients.

Ingestion comprises reading and parsing rules, including, for example, document requirements for each product. Particularly, rules for different products may be stored in a number of files such as spreadsheets. The spreadsheets comprise data which may be processed and compiled into rules documents using the reading and parsing, such as the “Document Requirements” file and the “Document Class Mapping” file, which are generally also spreadsheets. In some embodiments, the rules documents are saved in an internal database. The reader extracts relevant rules information from the text (e.g., strings) in the spreadsheets (an example type of first format). In particular, the reader extracts each column and row of the rules in the spreadsheet into a two-dimensional data structure, such as Python™ Pandas DataFrames™, although in some embodiments the reader can instead compile the extracted information into a text or spreadsheet file. Any columns/rows in the spreadsheet unrelated to the rules are simply deleted so that the subsequent parser has less work to do. Each cell in the source or compiled spreadsheets may correspond to one rule or attribute thereof such as a required document class, although each cell may also comprise multiple rules or rule attributes. As an example, one rule may identify multiple entity types that are required to provide a document for a particular class, with each entity type being an attribute of the rule.

The parser then takes the clean columns and rows of the DataFrames™ and tokenizes them into different attributes to enable clear mappings between rule, client, and product attributes and representations thereof. In particular, the parser reads the information extracted by the reader, and translates the rules into trigger conditions. The trigger conditions can be converted to JSON objects, which are stored and can be subsequently loaded by the handlers 304. The reader also compiles the rules and corresponding attributes, which are mapped to the trigger conditions and/or corresponding JSON objects. The compilation and mapping of the rules and attributes can be output in rules files such as the “Document Requirements” file, the “Document Class Mapping” file, and also a “Product Mapping” file that describes a list of all products offered by the financial institution. In some embodiments, the “Document Requirements”, “Document Class Mapping”, “Product Mapping” files may be already available or can be directly compiled and cleaned by the reader. Accordingly, the parser can perform the above-described mapping and generation of JSON objects without also compiling and outputting the files. An example of mappings in respect of example client attributes is presented below:

```
  client_attr_map = {
  “: None,
  “‘Does the Counterparty Have > 75% Free-Float Shares?’”: ”,
  ‘Applicable for all Canadian entity types': ”,
  ‘Booking Point’: ‘Booking Point’,
  ‘Booking Points': ‘Booking Point’,
  ‘CRR’: ‘Risk Rating’,
  ‘Capacity’: ”, # assuming not product capacity
  ‘Domicile Country’: ”, # Address Type?
  ‘Domiciled Address': ”, # Address Type?
  ‘Entity Type’: ‘Legal Entity Type’,
  ‘Exempt Reason’: ‘Exemption Reason (CA) List’,
  ‘Exempt Status': ‘Exemption Status',
  ‘Exemption Reason’: ‘Exemption Reason (CA) List’,
  ‘Exemption Status': ‘Exemption Status',
  “Is the financial institution acting as a custodian to debt the
  client/counterparty's DDA to transact on the Money Market
  facility?”: ”,
  ‘Jurisdiction’: ‘Jurisdiction’,
  ‘LE Type’: ‘Legal Entity Type’,
  ‘LE type’: ‘Legal Entity Type’,
  ‘Legal Entity’: ‘Legal Entity Type’,
  ‘Legal Entity Type’: ‘Legal Entity Type’,
  ‘Product’: ‘Product Type’,
  ‘Product Capacity’: ‘ProductCapacity’,
  ‘Product Category’: ‘Product Category’,
  ‘Product Type’: ‘Product Type’,
  ‘Product capacity’: ‘ProductCapacity’,
  ‘Risk Score’: ‘Risk Rating’,
  ‘Booking Entity’: ‘Booking Point’
}
```

In the above mapping, the values on the left side of the colon are values present in the rules when in the first format (e.g., cells of a spreadsheet), while the values on the right side of the colon are the corresponding terms expressed in the second format (e.g., the corresponding JSON objects).

An example mapping in respect of a product is provided below. In the following example, the reference to the product being “Bilateral” means the product is a repurchase agreement (“Repo”) product where there are two parties on either side of the trade. For each Product(x,y,z) entry, x refers to the booking point, y refers to the product category, and z refers to the product type.

“Bilateral”: {
Product(INSTITUTION_DS, “Central Funding”, “Repo - Bilateral”),
Product(TOR_TRANSIT, “Central Funding”, “Repo - Bilateral”),
Product(TOR_BRANCH, “Central Funding”, “Repo - Bilateral”),
Product(INSTITUTION_DS, “Central Funding”, “Securities Lending - Bilateral”),
Product(TOR_TRANSIT, “Central Funding”, “Securities Lending - Bilateral”),
Product(TOR_BRANCH, “Central Funding”, “Securities Lending - Bilateral”),
Product(TOR_BRANCH, “Corporate Banking”, “Bilateral”),
Product(INSTITUTION_DS, “Fixed Income”, “Rates Derivatives - Bilateral & XCCY
Swaps”),
Product(TOR_TRANSIT, “Fixed Income”, “Rates Derivatives - Bilateral & XCCY
Swaps”),
Product(TOR_BRANCH, “Fixed Income”, “Rates Derivatives - Bilateral & XCCY
Swaps”)

The reader and parser collectively tokenize the different attributes, which are unformatted in the source spreadsheets. This tokenization is effectively a common second format shared by the rules, document mappings, and product mappings, thereby allowing a repository comprising rules and document/product mappings that are tokenized to act as a repository for various rules and document/product mappings expressed in different first formats. Having such a repository with rules and mappings expressed in the same format regardless of source helps with scalability and efficiency.

As noted above, the rules executed by the rules engine 300 can themselves be provided in a Microsoft Excel™ spreadsheet. To extract the rules from source data (e.g., various spreadsheets), the reader imports spreadsheets containing the rules, each as a Pandas DataFrame™. Optionally, the reader may also filter rows and remove unneeded columns, rows, and/or cells. For example, in a source rules spreadsheet, a fourth column may be entitled “Comment” and contain a flag indicating whether the set of rules (e.g., trigger conditions) in the same row should be read or not.

From that imported spreadsheet, rules data corresponding to the trigger conditions (e.g., a column in the spreadsheet) is extracted and indexed with the key corresponding to the required document class by the parser. In the embodiment where the “Document Requirements” file is available as the spreadsheet, the “Trigger Conditions” column can be extracted to decipher the rules.

The parser then tokenizes the extracted, textual rules based on semantic patterns for each document requirement class's trigger conditions including:
1. Search through all trigger conditions if explicitly stated, replace ‘Condition:” with “ ”, then replace “+” with the newline character ‘\n’ to separate the trigger conditions.
2. Define two split regex patterns: ‘\n’ (newline split) and “; (?!\sOR)” (semicolon/OR split)
3. Combine the two regex patterns from 2 and using the “re” Python™ library, split the individual trigger conditions based on the combined pattern so that it splits based on either pattern (make conditions separated by a ;, ;OR, \n (newline), and placed in different elements in a Python list).
4. With the list created from 3, loop through each condition and replace ‘:’ with ‘=’, then split on ‘=’, stripping away any lingering whitespace.
5. From 4, find all cases of parentheses (A, B, C, D) and replace ‘,’ with ‘/’.
6. Split all potential values on the comma (,) character.
7. Store the results in a Python dictionary object of [trigger_name]->[list of possible values of the client attribute]. In other words, the dictionary object relates a particular trigger condition (trigger_name) to potential client attributes that may satisfy that trigger condition.

Based on the above, the parser can identify and extract individual trigger conditions. Once completed, the parser consolidates attribute names as standardized names, and product names are mapped to the product class specification, based on a mappings dictionary of which the Document Class Mapping file is an example.

The trigger conditions corresponding to the rules are subsequently converted into the second format, which in the present example embodiment is JSON (e.g., each trigger condition being converted to a JSON object). The rules are first serialized into a dictionary format, for example using a toJSON( ) method, and product masks are converted into strings, for example using a_str_( ) function. The rules, for example the individual trigger conditions corresponding thereto, are named, defined and/or indexed per document requirement class so that for each rule (e.g., trigger condition), the serialized object (a dictionary) is saved into JSON format and is titled using the sanitized document requirement class name. In this context, “sanitized” means removing any characters that may cause file system issues such as syntax errors when being loaded or read (e.g., replacing “/” with “\”). The converted rules/trigger conditions in JSON are stored to and form part of the rules repository (e.g., in an internal database) and are human readable, and can be used going forward in lieu of the original rules stored in the spreadsheet. The JSON objects corresponding to the rules and trigger conditions can also be regularly updated to account for changes by running the reader and parser at regular, predetermined intervals.

In at least some embodiments, the reader and parser can also analogously extract, convert, and store client and product attributes into the second format, for example as JSON objects in a dictionary repository or directory.

In operation, the rules engine 300 checks the repository for available rules in the second format (e.g., JSON). If they exist, those rules are loaded into application memory and applied by the handler 304. If those rules do not exist, the rules engine 300 ingests rules in one of more of the first formats (e.g., a Microsoft Excel™ spreadsheet) and converts them into the second format as per the above procedure. The rules loader also checks for cases where names have been sanitized, and reverts them to their original format. Following this, the converted rules are applied by the rules engine 300 as described above.

More particularly, each handler 304 retrieves and loads the corresponding rule/trigger condition from the JSON repository as a JSON object. The corresponding client or product attribute as specified in the trigger condition is then accessed by or provided to the handler 304 as a JSON object, which is compared to the attribute defined in the rule. A match of the attributes by the handler 304 would result the handler 304 evaluating the trigger condition to “True”. For example, the loaded rule for a handler 304 may generally correspond to: “Entity Type” is “A”. The handler then accesses the client attribute for “Entity Type”, which is “A”. Since the client attribute matches the attribute in the trigger condition (e.g., both being “A”), the handler evaluates the trigger condition as “True”.

### Rules Engine Implementation

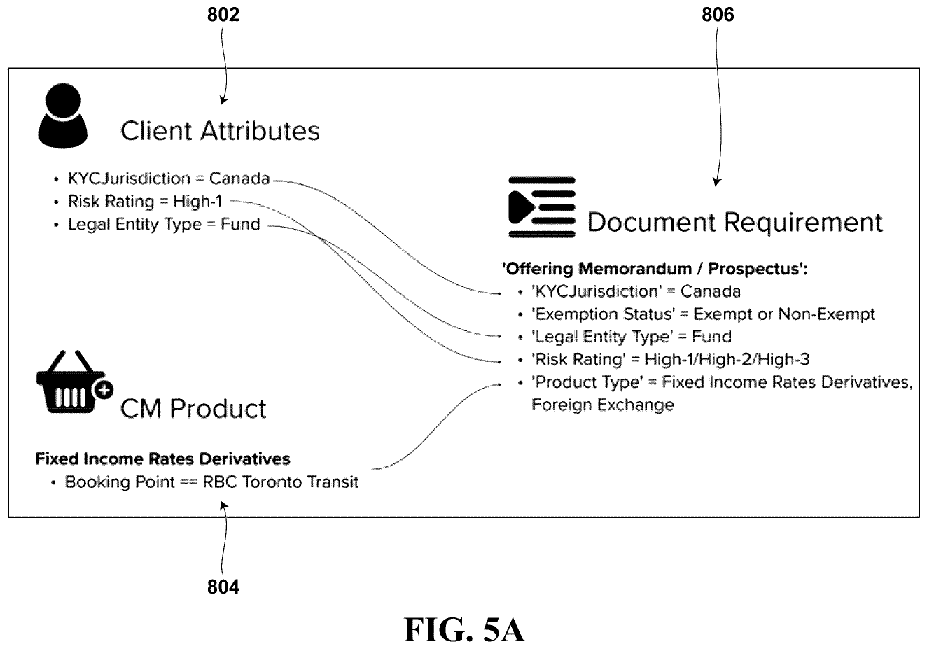

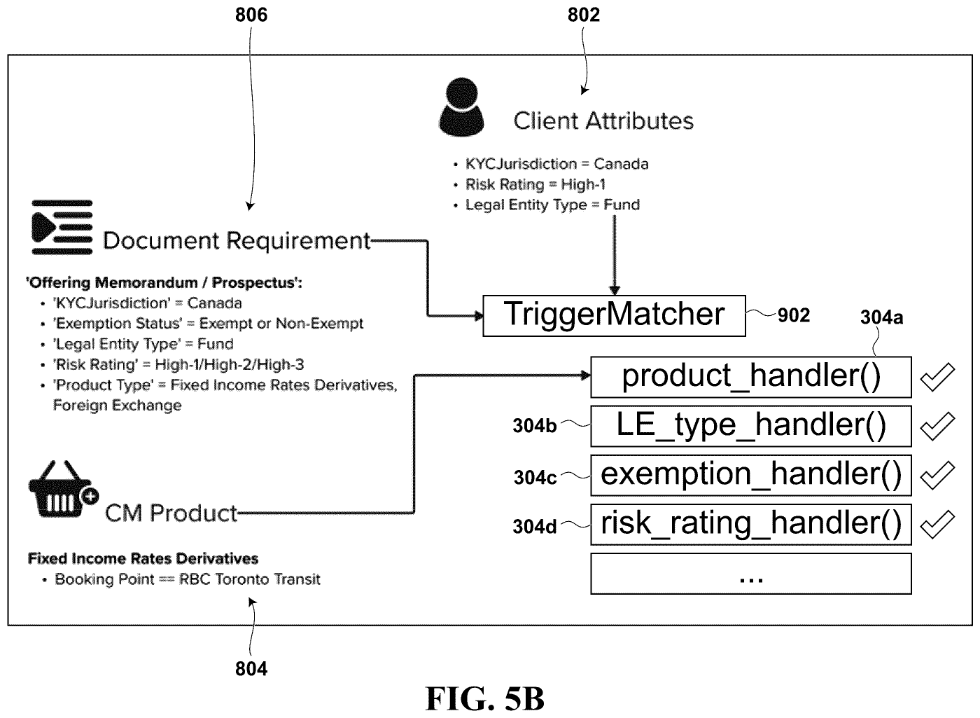

With references to FIGS. 5A and 5B, the rules engine 300 handles a number of different attributes. As described above, the rules engine 300 stores and manages rules in the form of trigger conditions, which can be outlined and defined as a series of document requirements attributes 806, listed in the “Document Requirements” file. In some embodiments, the document requirements attributes 806 are a dictionary repository of JSON objects, each corresponding to a trigger condition. In order to apply the rules as set out in the document requirements attributes 806 for one or more products, client attributes 802 and product attributes 804 are matched and evaluated against the document requirements attributes 806, as shown in FIG. 5A. As described above, attributes in the document requirements attributes 806 correspond to trigger conditions, which are evaluated based on the client attributes 802 and product attributes 804. The client attributes 802 comprise client information retrieved from the internal client database using a client identifier, as described above; and the product attributes comprise product information retrieved from the internal products database for each potential product. The document requirements attributes 806 are evaluated with respect to the product attributes 804 for each product using the client information in the client attributes 802 and the corresponding product information. The same set of document requirements may be applicable for multiple different products. In the current embodiment, the client attributes 802 are a plurality of software class objects each describing (e.g., comprising information for) a respective product.

Referring to FIG. 5B, the trigger conditions as out set in the document requirements attributes 806 are matched to client and product attributes 802, 804 using a trigger matcher 902. The trigger matcher 902 is a function or method that matches or maps the attributes in the product attributes 802, 804 to the corresponding attributes in the document requirements attributes 806 for each trigger condition. For example, a trigger condition based on “Entity Type” in the document requirements attributes 806 would be matched to the “Entity Type” attribute in the client attributes 802, which defines the entity type of the client. This matching can be performed based on the standardized names/classes of the attributes or using object/class matching. The matched attributes are passed to handlers 304 (e.g., handlers 304a-d in FIG. 5B), which evaluates the matched attributes against each other, results of which are used to populate the matrix 400. As described above, if information corresponding to the matched attributes are the same (e.g., the specified legal entity type for both the client and document requirement attributes are the same), the handler can evaluate to “True”, indicating that the corresponding document class for the document attribute is required for the client and product. More particularly, as the handlers 304 are executed in respect of each respective product (e.g., for each row in the matrix 400), a product handler 304a may be executed first for each cell on the row, corresponding to the evaluation of document requirements for the respective product. The first execution of this handler indicates the start of a new row (for a new/subsequent product). After executing the product handler 304a for each cell, the subsequent handlers 304b-d are also executed (if required) for each cell, the results of the handlers 304a-d are then used to populate the new row. The use of the product handler 304a as the first handler can simplify the evaluation process as it is the broadest or most basic trigger condition, as well as improve handler organization as it is shared for all cells in the same row (e.g., for the same product). In some embodiments, the trigger matcher 902 comprises the handlers 304. Alternatively, each handler may be paired or comprise a respective trigger matcher.

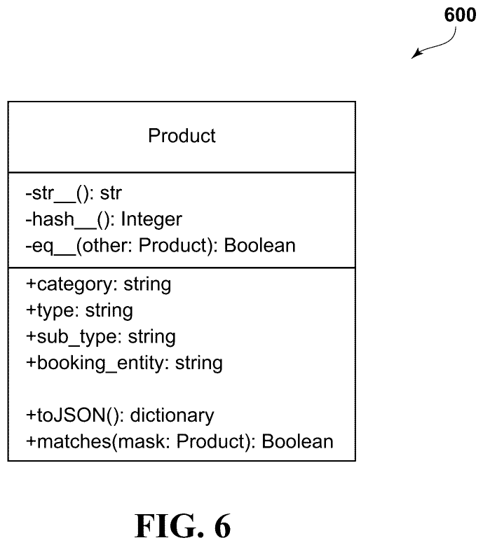

Referring now to FIG. 6, the rules engine 300 stores and processes product attributes and information using a product class definition 600, such as shown in FIG. 6, which is a software class object that describes a product that may be sold to a client. Also stored in the rules engine 300 are digitized rules as described above, which are parsed from a first format (e.g., a spreadsheet) into a second format (e.g., JSON) using the parser as described above; and the trigger matcher 902, which is software built using chain-of-command design pattern designed to handle individual trigger conditions.

As described above, for every client, the rules engine 300 generates the matrix 400, which is a table/array of Boolean values, with each row describing a different product sold by the institution and each column describing a different document requirement class. The handlers 304, fill the matrix 400, relying on the transformed rules (e.g., JSON objects) and client data (e.g. client attributes 802) stored within a client data repository (e.g., Fenergo™ FenE™/FenX™ software). The rules engine 300 collates client attributes retrieved from FenE™/FenX™ software and passes it to the rules parser, which applies the rules using the handlers 304 to derive the matrix 400.

Each of the rules when encoded in the second format (e.g., JSON), are grouped by document requirement class and have the following structure:
1. Applicable product(s) and/or product category(s).
2. Applicable jurisdiction.
3. Required client attribute values.

Each document requirement class has a list of rules in the form of “trigger conditions” such that if all trigger conditions are satisfied (e.g., all trigger conditions evaluate to “True”) in respect of a particular product and client, the client would be required to provide a document falling within the required document class for that product. To qualify for the particular product, the client is required to provide documents for all required classes as identified. The trigger conditions and document class requirement are processed dynamically by the handler 304 mentioned above and described further below. More particularly, the rules engine 300 dynamically dispatches the appropriate handler for each trigger condition based on the trigger conditions required for the document class, and a cell in the matrix 400 is only labeled “True” if all corresponding handlers 304 return true (e.g., all trigger conditions for the document class is satisfied). For example, for each cell, the rules engine 300 determines the corresponding trigger conditions required to evaluate whether the corresponding class of document is required for the corresponding product (e.g., based on/as defined in the “Document requirements” file) and only dispatches the handlers corresponding to the required trigger conditions. Dynamic dispatching helps reduce compute requirements relative to static dispatching as triggers not present are not being checked by a handler. In the current embodiment, each handler is only responsible for checking a single trigger condition, but may be used for multiple document classes/products.

For example, and as discussed above, various trigger conditions for a particular product may each correspond to a rule attribute such as a particular jurisdiction (e.g., Canada); an exemption status (e.g., exempt or non-exempt); a legal entity type (e.g., a fund); a risk rating indicative of how risky that product is (e.g., High/Medium/Low); and a product type (e.g., foreign exchange). These trigger conditions, in particular the corresponding rule attributes, can be compared against the corresponding client attributes 802 (e.g., the client's jurisdiction of residence; the client's risk rating/tolerance; and the type of legal entity the client is). The trigger matcher 902 receives the trigger conditions (e.g., document requirement attributes 806 defining rule attributes), product attributes 804 (e.g., in the form of product class 600), and client attributes 802, matches the appropriate client or product attributes, depending on the trigger condition, with the rules governing the trigger conditions that require those client/product attributes as inputs, and then dynamically dispatches various trigger conditions to a series of successively dispatched handlers 304 to populate the matrix 400 as described herein. In particular, for each cell (e.g., each document class), the handlers 304 responsible for evaluating the corresponding trigger conditions are dispatched, for example determined from the “Document Requirements” file.

A “True” value in the matrix 400 accordingly indicates that supplying a document of the document class is required for the client to qualify for purchasing the corresponding product. As multiple documents may fall under the same document class, a document class requirement may be fulfilled using different types of documents as described above in respect of the “Document Class Mapping” file. Insights may subsequently be derived from completed matrices 400 by having the rules engine 300 run Boolean operations on various rows or columns of respective matrices 400, each of which is implemented as a Pandas DataFrame™ object.

Insights derived from the matrices 400 may be communicated to a front-end via web pages implemented using JavaScript™, React™, and NextJS™, for example. A Flask™ server and API may be used to communicate between the front and back-ends. Querying the back-end involves the front-end sending a GET request via the API with the client's unique credentials, and results in the front-end obtaining a JSON payload from the back-end.

Each product that may be sold to a client is represented as a product class 600, such as shown in FIG. 6. As per FIG. 6, each product class 600 comprises the following string fields:
1. Category: The category of financial product. Example categories comprise: Central Funding, Commodities, Corporate Banking, Fixed Income, Fixed Income Origination, Foreign Exchange Futures, Global Equities, Equity Derivatives, Global Investment Banking, Treasury Services (TMS), Mortgage Investment Group, Corporate Client Group, Research, Credit Derivatives, US Cash Management.
2. Type: The type of financial product. Example product types, which are specific product examples under a particular product category, comprise rates derivatives (under the Fixed Income product type) and Spot FX Only (under the Foreign Exchange product type).
3. Sub_type: The sub-type of financial product. Similar product type, these are further categorized under the product type. For example, a “OTC Equity Derivatives” product type may be in the product category, “Equity Derivatives”, and may have sub-types such as “single stock options” and “broad based index”. Sub-type may be an empty field.
4. Booking_entity: The financial institution entity at which the product is booked. An example is, for example, XYZ Institution in Toronto, Canada.

The product class 600 also comprises the following methods:
1. _str_: This converts the product into text according to the following Python™ string substitution logic. It appends each field's values (e.g., Category, Type, Sub_type, Booking_entity) into one string, allowing for printing of the object, and hashing of the object as a unique value.
   fProduct Category: {self.category}|Product Type: {self.type}|
   Product Sub Type: {self.sub_type}|Booking Entity:
   {self.booking_entity}′
2. _hash_: This returns the hash of the string equivalent of the product class 600. It provides a unique hash value for the product so that it can more efficiently be put into a set (i.e., a Python™ container for multiple objects with quick lookup operations). This facilitates fast searching to determine whether a product forms part of a particular set of products.
3. eq_: This is an overload of the Python “==” operator, which only returns True if the type, sub_type, and booking_entity are equivalent between two instances of the product class 600 (e.g., two products are the same).
4. Matches: a function that checks if a specific instance of the product class 600 matches a “product requirement mask”. For an example class instance (this product), this function is called as this_product.matches(mask), and returns true if this_product is falls under the “mask”. One product (X) “falls under” another product (Y) if all of the following is true:
   X.booking_entity==Y.booking_entity
   Y.(category/type/sub_type) is None
   Y.(category/type/sub_type) matches X.(category/type/sub_type)
   As shown above, to match the product requirement mask, the product must share the same booking entity and have no product sub-type.
   A product requirement mask defines a group of products in which a specific product falls under the mask if at the lowest/most granular level of the product definition, the specific product attribute is equal to the respective product mask, and all higher/less granular levels are the same. As such, the product requirement mask can be used to identify acceptable or equivalent products under a product class.

Also included in the product class 600 is a toJSON( ) method, which converts the product class object to a JSON object and stores it to a product or attribute dictionary.

All products are initially defined in a spreadsheet (e.g., Microsoft Excel™ document). The file is read using the Python™ Pandas™ library and converted to a Pandas DataFrame™. Due to cell merging, the front fill (ffill( )) Python™ method is run on all columns that are not “Product Sub Type” and “Capacity” to ensure mappings are consistent once cell merges are removed during the Pandas™ import. The columns “Category”, “Type”, “Sub Type”, and “Booking Entity” are then extracted.

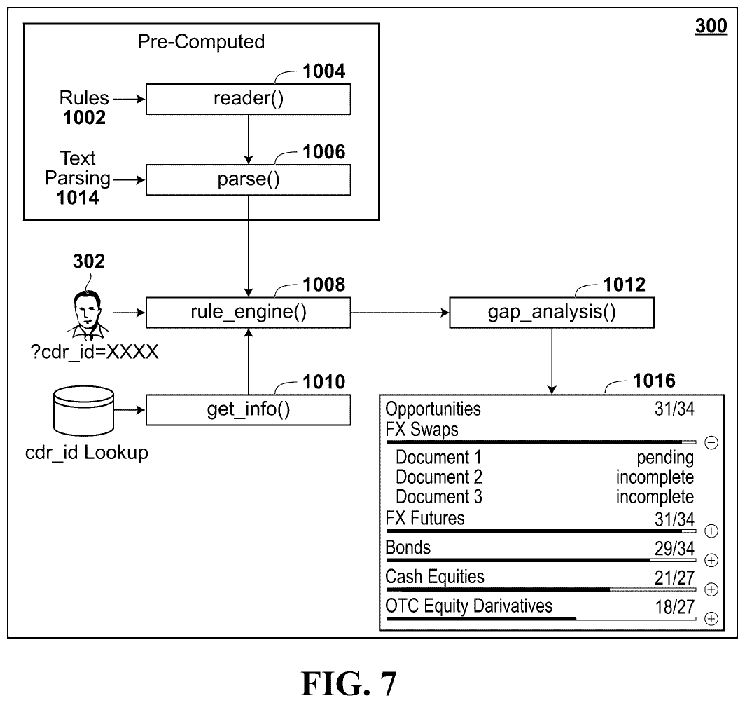

A block diagram of the rules engine 300 is shown in FIG. 7. Namely, FIG. 7 shows the reader and parser, respectively executed by calling the functions reader( ) 1004 and parse( ) 1006. As described above and as shown in FIG. 7, the reader and parser collectively take rules from spreadsheets 1002 and convert them into JSON form; this may be done any time in advance of running the rules engine 300. Alternatively, if the rules are not in JSON form when the rules engine 300 is ready to be executed, the reader( ) and parse( ) functions 1004, 1006 may be executed to convert the rules into JSON format at runtime. More specifically, the reader( ) function 1004 ingests the spreadsheets 1002, removing irrelevant information and empty rows/columns. The “Document Requirements”, “Document Class Mapping”, “Product Mapping” files are also generated by compiling the cleaned data using the reader( ) function 1004, if possible. The processed data (e.g., cleaned spreadsheets) are input to the parse( ) function 1006, which processes the input data as strings containing the rules (1014). The parse( ) function 1006 converts the rules into JSON objects; standardizes the attributes within the rules and maps them to the JSON objects.

The rules engine 300 may then be executed by calling the rule_engine( ) function 1008. In order to acquire the client's 302 attributes and trigger conditions, the get_info( ) function 1010 is called to retrieve the client data from a first internal database using the client's unique identifier. With this information, the rules engine 300 generates one or more matrices 400 as described above. The one or more matrices 400 may be analyzed using the gap_analysis( ) function 1012 to identify which products have the fewest document requirements, and consequently would likely be the simplest to sell to the client 302. The analysis results can be output in the form of a report 1016. The report 1016 can indicate, amongst other information, the number of additional documents required from the client 302 for each product, percentage of required documents provided for each product (e.g., as a pie chart or progress bar of the required documents already provided), as well as which documents the client 302 needs to provide to qualify for each product. The process for converting raw rules into JSON format, if that pre-computation has not already been done; through to generating and analyzing a matrix 400 for insights is as described above and further below.

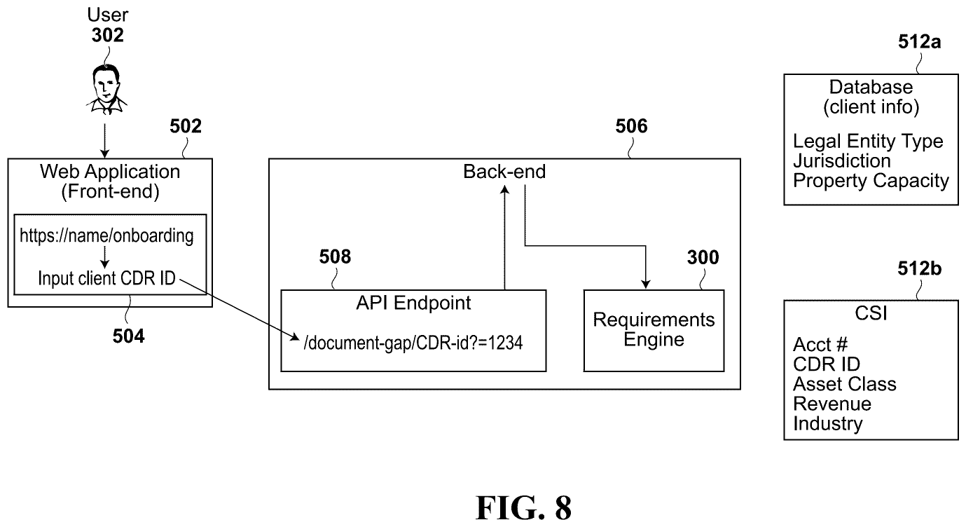

FIG. 8 shows an architecture diagram of a system comprising the above-described rules engine 300, according to an example embodiment. The architecture diagram shows the front-end 502, which comprises a web application 504 or suitable user interface; a back-end 506, which comprises an API endpoint 508 that communicatively couples the back-end 506 to the front-end's 502 web application 504; the rules engine 300, that reads, parses, and applies the rules as described above; and first and second internal databases 512a,b. The first database 512a, which may be implemented using Fen-X™ software, stores client attributes 802 such as the client's legal entity type, jurisdiction, and product capacity (an attribute that describes what type of products or what line of business the client primarily deals with) The second database 512b stores the client's account number, unique identifier, asset class, revenue, and industry. When the rules are applied, the back-end obtains the client's credentials/identifier from the web application 504 via the API endpoint 508; the rules engine 300 pulls the corresponding client attributes from the databases 512a,b; and the rules engine 300 then applies the rules. The product attributes are also pulled from an internal database (not shown) and used for applying rules.

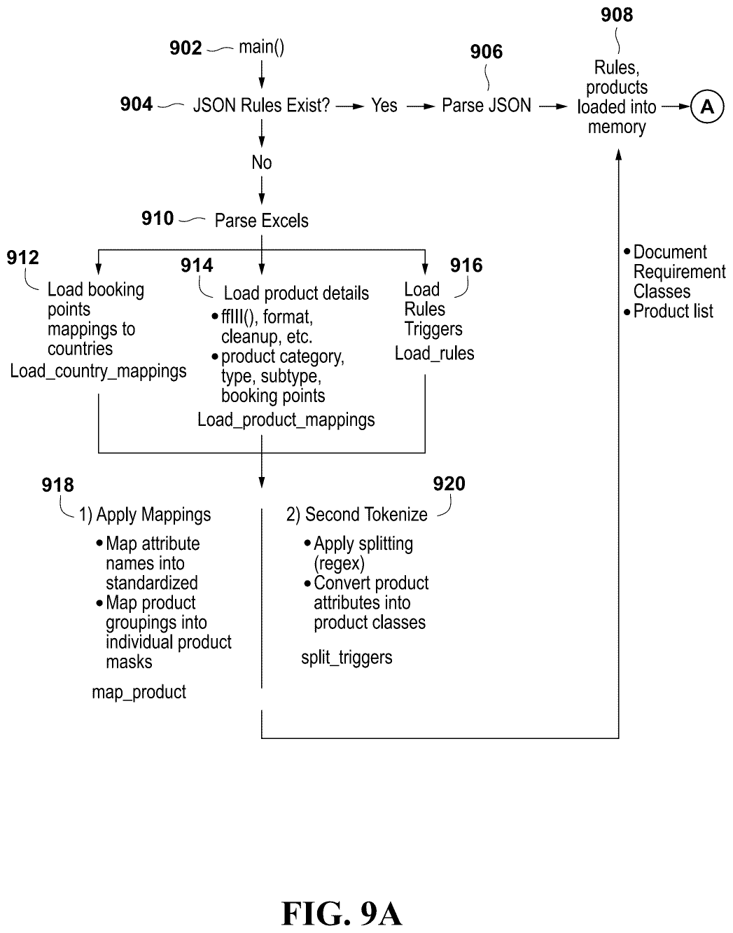

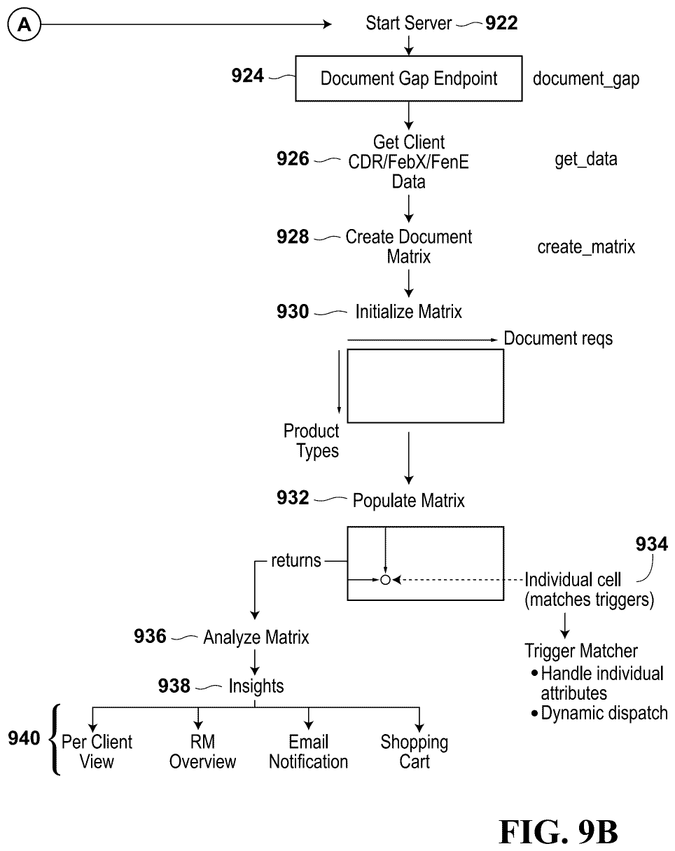

FIGS. 9A and 9B show a flowchart depicting a method for applying the rules engine to generate the matrix, according to an example embodiment. Note that other orders of the depicted steps are possible as well.

At 902 the rules engine 300 is initialized and/or invoked. At 904, the rules engine 300 performs a search of the internal database(s), particularly in a dictionary repository of rules/product information in a particular data format, in this embodiment JSON objects and/or class objects. More particularly, the repository can have stored therein document requirement rules in a particular data format, for example JSON objects and product information/attributes in a particular data format, for example class objects or JSON objects. The document requirement rules can correspond to trigger conditions for a plurality of documents, where if all trigger conditions are satisfied in respect of a product, a client is required to provide a document of the corresponding class in order to qualify for the product.

If the rules and/or product information are not present in the directory (“No” at 904) in the particular data format (e.g., as JSON objects), the method moves to 910. At 910, the rules engine 300 searches the internal database(s) for relevant documents containing document requirement rules and/or product information. In the current embodiment, the relevant documents are spreadsheets. Further, a reader or read function is invoked to process, clean, standardize, and compile the relevant documents, as described above. For example, empty rows and columns and/or rows and columns containing irrelevant information can be removed. A parser or parse function is then invoked to process information from the reader to extract rules and product information, as described above. For example, booking points are extracted at 912, product information is extracted at 914, and document requirement rules are extracted at 916. To extract the rules and product information, the processed documents (e.g., spreadsheets) can be further formatted and cleaned, with the relevant attributes of rules/products identified and extracted.

At 918, mapping is performed on the attributes in the extracted rules and product information by consolidating attribute names as standardized names, with products being standardized and grouped, for example using product masks (to group equivalent products under a product class). At 920, the rules and product information are tokenized into the desired data format, as described above. In particular, the product attributes can be converted into product classes and the rules can be converted into JSON objects corresponding to trigger conditions, where each product requirement rule can also be further split into individual trigger conditions. The converted rules and product information can be stored in the dictionary repository saved to an internal database and subsequently loaded into the memory of the rules engine 300 at 908 for processing when needed. The trigger conditions can also be used to initialize handlers 304, which can be invoked subsequently when required. The reader and parser can also generate the “Document Requirement”, “Document Class Mapping” and/or “Product Mapping” files from the extracted information, which are also saved to an internal database and can be loaded into memory at 908 for processing when required.

If the rules and/or product information are already present in the directory (“Yes” at 904) in the particular data format (e.g., as JSON objects), for example having been previously generated, the method moves to 906. At 906, the relevant product information and rules may be parsed, retrieved, and loaded into memory at 908.

To perform required document analysis on one or more products for a client, a user interacts with the rules engine 300 at 922, for example by starting and interacting with the server hosting the rules engine 300. In particular, the user can, at 924, use an API endpoint to interact with the server/rules engine 300. In some embodiments, the user can also initiate rules extraction (e.g., 910-920) as needed. To access client attributes, the user can provide a client identifier used to retrieve client information from an internal database at 926. The “Document Requirement”, “Document Class Mapping” and/or “Product Mapping” files may also be retrieved from an internal database or provided by the user.

At 928, the matrix 400 is created. At 930, the matrix 400 is initialized for all available products or a selection thereof provided by the user, the size of which depends on the number of products and possible document classes. At 932, the matrix 400 is populated by iterating through each cell. To populate each cell, the rules engine 300 dynamically dispatches the corresponding handlers 304 at 934, each loaded with (e.g., a JSON object) and configured to evaluate a specific trigger condition. Each handler 304 evaluates the respective attribute of the trigger condition against a corresponding client or product attribute, returning “True” for a match. A “True” evaluation indicates that one of the trigger conditions for requiring the corresponding document class has been met. The cell is marked “True” if all handlers return “True”. If any handler returns “False”, the cell is marked “False” and the rules engine 300 without further computation for the same cell.

The user can analyze the matrix 400 at 936, for example to determine the number of required document classes for the client based on documents that have already been provided by the client. Insights can be derived at 938, for example by generating the report 1016, comprising information pertaining to the number of additional required document classes from the client for each product. The insights can be communicated at 940. For example, the report 1016 can be forwarded to the client and/or internal managers, such as over email or SMS. A salesperson and/or client can also use the insights to perform product purchasing/onboarding, for example based on which products are easiest to onboard (e.g., requiring the least number of additional documents).

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, additional example processing units comprise an application-specific integrated circuit (ASIC), field programmable gate array (FPGA), system-on-a-chip (SoC), artificial intelligence accelerator, or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a processor” or “the processor” does not exclude embodiments in which multiple processors are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

It is contemplated that any part of any aspect or embodiment discussed in this specification can be implemented or combined with any part of any other aspect or embodiment discussed in this specification, so long as such those parts are not mutually exclusive with each other.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A rules engine application method, the method comprising:
(a) obtaining trigger conditions corresponding to rules defining document requirements for at least one product to be evaluated in respect of a client, and client data pertaining to the client;
(b) applying the rules by evaluating the trigger conditions using the client data in respect of the at least one product; and
(c) as a result of applying the rules, generating a document requirement matrix, the document requirement matrix comprising, for each of the at least one product, an indication for each of a plurality of document classes corresponding to whether the client is required to provide a document of the respective document class to purchase a respective product.

2. The rules engine application method of claim 1, wherein each cell of the document requirement matrix is populated with a Boolean value corresponding to the indication of whether the client is required to provide the document of the respective document class to purchase the respective product.

3. The rules engine application method of claim 2,
(a) wherein each of the trigger conditions corresponds to a rule or attribute thereof;
(b) wherein each of the trigger conditions is evaluated using a handler function that outputs the Boolean value representing whether a respective trigger condition is satisfied;
(c) wherein any one handler function returning a false Boolean value for a particular cell of the matrix results in the particular cell being false and all handler functions returning a true Boolean value for the particular cell results in the particular cell being true; and
(d) wherein the particular cell being false represents that one of the trigger conditions for requiring the client to provide the document of the respective document class is unsatisfied, and the particular cell being true represents that all of the trigger conditions for requiring the client to provide the document of the respective document class are satisfied.

4. The rules engine application method of claim 3,
(a) wherein each of the trigger conditions corresponds to a respective attribute of the rules and a respective attribute of the at least one product or the client data; and
(b) wherein the handler function returns the true Boolean value if the respective attribute of the rules matches the respective attribute of the at least one product or the client data.

5. The rules engine application method of claim 4, wherein a trigger matcher function maps the respective attribute of the rules to the respective attribute of the at least one product or the client data for the handler function.

6. The rules engine application method of claim 3, wherein the handler function is dynamically dispatched for each cell based on the respective document class and the respective product.

7. The rules engine application method of claim 1, wherein the rules are obtained in one or more first formats and, prior to the applying of the rules, the method further comprising converting the rules into a shared second format.

8. The rules engine application method of claim 7, wherein the converting of the rules comprises:
(a) processing the rules in the one or more first formats to extract relevant rules information;
(b) splitting the relevant rules information into individual trigger conditions; and
(c) tokenizing the individual trigger conditions to map attributes in the individual trigger conditions into standardized terms.

9. The rules engine application method of claim 8,
(a) wherein the rules in the one or more first formats are stored in a spreadsheet;
(b) wherein the shared second format is JavaScript Object Notation (JSON); and
(c) wherein the individual trigger conditions each corresponds to a respective JSON object.

10. The rules engine application of claim 9,
(a) wherein the processing of the rules comprises:
(i) extracting rows and columns of the spreadsheet into a two-dimensional data structure;
(ii) removing irrelevant rows and columns to extract the relevant rules information; and
(iii) indexing the relevant rules information based on the plurality of document classes;
(b) wherein the splitting of the rules comprises extracting the individual trigger conditions using regex and splitting conditions; and
(c) wherein the tokenizing of the individual trigger conditions comprises:
(i) converting the individual trigger conditions into dictionary objects;
(ii) consolidating the attributes in the individual trigger conditions into the standardized terms; and
(iii) converting each of the individual trigger conditions into the respective JSON object.

11. The rules engine application method of claim 9, further comprising: storing the rules of the shared second format in a repository, wherein the applying of the rules comprises loading the handler function with the respective JSON object retrieved from the repository.

12. The rules engine application method of claim 11, further comprising: prior to the applying of the rules, parsing the repository for the rules of the shared second format, wherein the converting of the rules is dependent on the parsing determining that the rules of the shared second format are not available.

13. The rules engine application method of claim 1, further comprising: retrieving product information for the at least one product, wherein the trigger conditions comprise a trigger condition evaluated using the product information.

14. The rules engine application method of claim 13,
(a) wherein the product information is obtained in one or more third formats and, prior to the applying of the rules, the method further comprising converting the product information into a fourth format;
(b) wherein the fourth format is a class object; and
(c) wherein the converting of the product information comprises:
(i) processing the product information in the one or more third formats to extract relevant product information;
(ii) tokenizing the relevant product information to map attributes in the relevant product information into standardized terms; and
(iii) grouping classes of the at least one products using a product matching function.

15. The rules engine application method of claim 13,
(a) wherein the class object defines a product category, a product type, a product sub-type, a product booking entity, or combinations thereof;
(b) wherein the class object comprises a string method for printing the class object, a hash method for returning a hash value of the class object, a conversion method for converting the class object into a corresponding JSON object, or combinations thereof; and
(c) wherein the class object comprises the product matching function, the product matching function configured to group the classes of the at least one product based on the product category, the product type, the product sub-type, the product booking entity, or combinations thereof.

16. The rules engine application method of claim 1, wherein the applying of the rules comprises: ingesting a first file comprising the trigger conditions for the at least one product, and a second file identifying acceptable documents for the plurality of document classes.

17. The rules engine application method of claim 1, further comprising: evaluating the document requirement matrix against document information corresponding to documents provided by the client to determine additional documents to be provided by the client to purchase the at least one product, wherein the client data comprises the document information.

18. The rules engine application method of claim 1,
(a) wherein the rules engine is implemented on a back-end of a server system and communicatively coupled to a user interface implemented on a front-end of the server system using an API endpoint;
(b) wherein the back-end of the server system hosts at least one first internal database storing the client data, the client data retrievable on a basis of a client identifier received from the user interface; and
(c) wherein the back-end of the server systems hosts at least one second internal database storing the trigger conditions.

19. A rules engine comprising at least one processing unit configured to perform a rules engine application method comprising:
(a) obtaining trigger conditions corresponding to rules defining document requirements for at least one product to be evaluated in respect of a client, and client data pertaining to the client;
(b) applying the rules by evaluating the trigger conditions using the client data in respect of the at least one product; and
(c) as a result of applying the rules, generating a document requirement matrix, the document requirement matrix comprising, for each of the at least one product, an indication for each of a plurality of document classes corresponding to whether the client is required to provide a document of the respective document class to purchase a respective product.

20. At least one non-transitory computer readable medium having stored thereon computer program code that is executable by at least one processor and that, when executed by the at least one processor, causes the at least one processor to perform a rules engine application method comprising:
(a) obtaining trigger conditions corresponding to rules defining document requirements for at least one product to be evaluated in respect of a client, and client data pertaining to the client;
(b) applying the rules by evaluating the trigger conditions using the client data in respect of the at least one product; and
(c) as a result of applying the rules, generating a document requirement matrix, the document requirement matrix comprising, for each of the at least one product, an indication for each of a plurality of document classes corresponding to whether the client is required to provide a document of the respective document class to purchase a respective product.
